(19) United States
(12) Patent Application Publication
(10) Pub. No.: US 2009/0048757 A1
(43) Pub. Date: Feb. 19, 2009

(54) CONTROL STRATEGY FOR TRANSITIONING AMONG COMBUSTION MODES IN AN INTERNAL COMBUSTION ENGINE

(75) Inventors: Chen-Fang Chang, Troy, MI (US); Jun-Mo Kang, Ann Arbor, MI (US); Jyh-Shin Chen, Troy, MI (US); Man-Feng Chang, Troy, MI (US)

Correspondence Address: CICHOSZ & CICHOSZ, PLLC, 129 E. COMMERCE, MILFORD, MI, 48381, US

(73) Assignee: GM GLOBAL TECHNOLOGY OPERATIONS, INC., DETROIT, MI (US)

(21) Appl. No.: 12/181,348

(22) Filed: Jul. 29, 2008

Related U.S. Application Data
(60) Provisional application No. 60/955,635, filed on Aug. 13, 2007.

(51) Int. Cl. F02D 41/00

(52) U.S. Cl. 701/102; 123/295

(57) ABSTRACT

An internal combustion engine is selectively operative in one of a plurality of combustion modes. Engine operation is monitored and program code is concurrently executed to operate the engine in a first combustion mode and in a second combustion mode. The engine is preferentially operated in the second combustion mode when the engine operation is within a predetermined area, and selectively operated in the first combustion mode based upon the monitored engine operation.

### CROSS REFERENCE TO RELATED APPLICATIONS

This application claims the benefit of U.S. Provisional Application No. 60/955,635 filed on Aug. 13, 2007 which is hereby incorporated herein by reference.

### TECHNICAL FIELD

This disclosure relates to operation and control of internal combustion engines.

### BACKGROUND

The statements in this section merely provide background information related to the present disclosure and may not constitute prior art.

Known spark-ignition (hereafter ‘SI’) engines introduce an air/fuel mixture into each cylinder which is compressed in a compression stroke and ignited by a spark plug. Known compression ignition engines inject pressurized fuel into a combustion cylinder near top dead center (hereafter ‘TDC’) of the compression stroke which ignites upon injection. Combustion for both gasoline engines and diesel engines involves premixed or diffusion flames controlled by fluid mechanics.

SI engines can operate in a variety of different combustion modes, including a homogeneous SI (hereafter ‘SI-H’) combustion mode or a stratified-charge SI (hereafter ‘SI-SC’) combustion mode. In a SI-H combustion mode, the cylinder charge is homogeneous in composition, temperature, and residual exhaust gases at timing of spark-ignition. Fuel mass is uniformly distributed around the cylinder chamber at spark timing which occurs near the end of the compression stroke. The air/fuel ratio is preferably stoichiometric. In a SI-SC combustion mode, the air/fuel ratio can be lean of stoichiometry. The fuel mass is stratified in the cylinder chamber with rich layers around the spark plug and leaner air/fuel areas further out. Fuel timing can be close to spark timing to prevent the air/fuel mixture from homogenizing into a uniformly disbursed mixture. The fuel pulse width can end as the spark event begins or substantially prior. Upon ignition, the rich layers burn quick and efficiently. As the combustion process proceeds into the leaner areas, the flame-front cools rapidly resulting in lower NOx emissions.

SI engines can be adapted to operate in a homogeneous-charge compression-ignition (hereafter ‘HCCI’) combustion mode, also referred to as controlled auto-ignition combustion, under predetermined speed/load operating conditions. The controlled auto-ignition combustion comprises a distributed, flameless, auto-ignition combustion process that is controlled by oxidation chemistry. An engine operating in the HCCI combustion mode has a cylinder charge that is preferably homogeneous in composition, temperature, and residual exhaust gases at intake valve closing time. Controlled auto-ignition combustion is a distributed kinetically-controlled combustion process with the engine operating at a dilute air/fuel mixture, i.e., lean of an air/fuel stoichiometric point, with relatively low peak combustion temperatures, resulting in low NOx emissions. The homogeneous air/fuel mixture minimizes occurrences of rich zones that form smoke and particulate emissions.

In an engine configured for multiple combustion modes, switching between the different combustion modes can be advantageous. Different combustion modes in similar speed/load situations can have performance differences in engine stability, emissions, and fuel economy. Transitioning to a particular mode with the best performance in a particular situation is therefore preferable. Selecting a combustion mode in which to operate can be based upon which combustion mode performs better at a particular engine load and speed. When a change in speed and/or engine load warrants the switch to a different combustion mode, a transition strategy will be performed and the engine will transition to the different combustion mode.

As the number of combustion modes increases, transitioning between combustion modes and coordinating transitions can be complex. The engine control module must be capable of operating the engine in multiple combustion modes and switching among them seamlessly. Without a switching strategy, a significant transient response may occur resulting in incomplete combustion and misfires, leading to torque disturbances and/or undesirable emissions.

### SUMMARY

An internal combustion engine is selectively operative in one of first and second combustion modes. A method for operating the engine includes monitoring an engine operating point and concurrently executing a first algorithm operable to control the engine in the first combustion mode and executing a second algorithm operable to control the engine in the second combustion mode. The engine is preferentially operated in the second combustion mode when the engine operating point is within a predetermined operating area for the second combustion mode, and selectively operated in the first combustion mode.

### BRIEF DESCRIPTION OF THE DRAWINGS

One or more embodiments will now be described, by way of example, with reference to the accompanying drawings, in which:

FIG. 1 is a schematic drawing of an exemplary engine system, in accordance with the present disclosure;

FIG. 2 graphically illustrates exemplary speed and load operating areas for various combustion modes, in accordance with the present disclosure;

FIG. 3 graphically illustrates an exemplary speed-load map superimposed atop the default combustion mode, in accordance with the present disclosure;

FIG. 4 is a schematic block diagram of a control scheme, in accordance with the present disclosure; and

FIGS. 5A and 5B graphically illustrate exemplary transitioning schemes, in accordance with the present disclosure.

### DETAILED DESCRIPTION

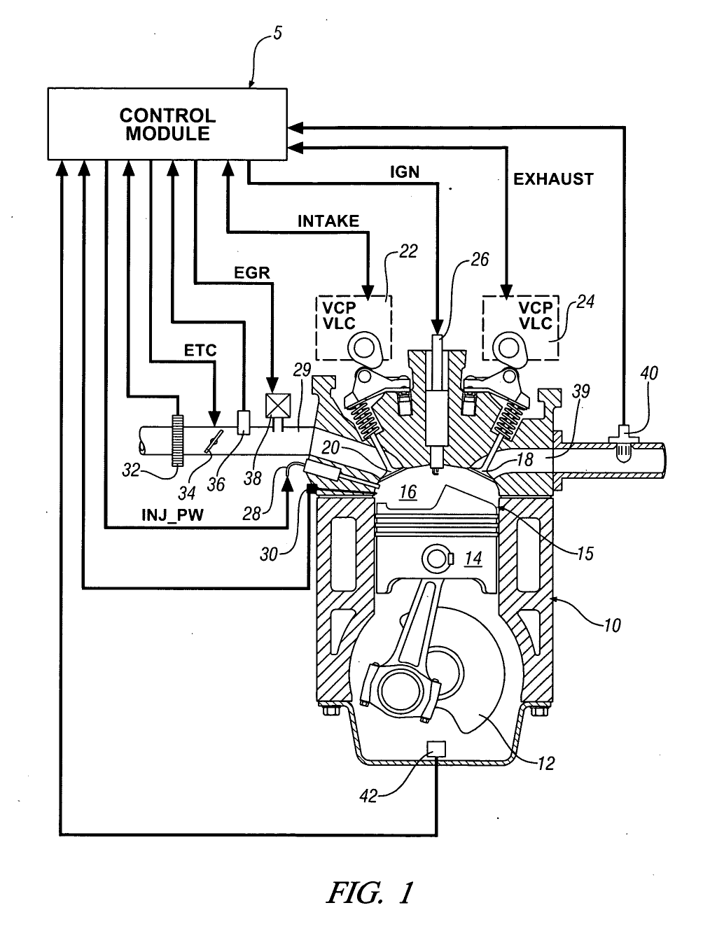

Referring now to the drawings, wherein the depictions are for the purpose of illustrating certain exemplary embodiments only and not for the purpose of limiting the same, FIG. 1 schematically shows an internal combustion engine 10 and accompanying control module 5. The engine 10 is selectively operative in a controlled auto-ignition combustion mode, a homogeneous spark-ignition combustion mode, and a stratified-charge spark-ignition combustion mode.

The exemplary engine 10 comprises a multi-cylinder direct-injection four-stroke internal combustion engine having reciprocating pistons 14 slidably movable in cylinders 15 which define variable volume combustion chambers 16. Each piston 14 is connected to a rotating crankshaft 12 by which their linear reciprocating motion is translated to rotational motion. An air intake system provides intake air to an intake manifold 29 which directs and distributes air into an intake runner to each combustion chamber 16. The air intake system comprises airflow ductwork and devices for monitoring and controlling the air flow. The air intake devices preferably include a mass airflow sensor 32 for monitoring mass airflow and intake air temperature. A throttle valve 34 preferably comprises an electronically controlled device which controls air flow to the engine 10 in response to a control signal (‘ETC’) from the control module 5. A pressure sensor 36 in the manifold is adapted to monitor manifold absolute pressure and barometric pressure. An external flow passage recirculates exhaust gases from engine exhaust to the intake manifold, having a flow control valve, referred to as an exhaust gas recirculation (‘EGR’) valve 38. The control module 5 is operative to control mass flow of exhaust gas to the intake manifold 29 by controlling opening of the EGR valve 38.

Air flow from the intake manifold 29 into each of the combustion chambers 16 is controlled by one or more intake valves 20. Flow of combusted gases from each of the combustion chambers 16 to an exhaust manifold 39 is controlled by one or more exhaust valves 18. Openings and closings of the intake and exhaust valves 20 and 18 are preferably controlled with a dual camshaft (as depicted), the rotations of which are linked and indexed with rotation of the crankshaft 12. The engine 10 is equipped with devices for controlling valve lift of the intake valves and the exhaust valves, referred to as variable lift control (hereafter ‘VLC’) devices. The variable lift control devices in this embodiment are operative to control valve lift, or opening, to one of two distinct steps, e.g., a low-lift valve opening (about 4-6 mm) for low speed, low load engine operation, and a high-lift valve opening (about 8-10 mm) for high speed, high load engine operation. The engine is further equipped with devices for controlling phasing (i.e., relative timing) of opening and closing of the intake and exhaust valves 20 and 18, referred to as variable cam phasing (‘VCP’), to control phasing beyond that which is effected by the two-step VLC lift. There is a VCP/VLC system 22 for the intake valves 20 and a VCP/VLC system 24 for the engine exhaust valves 18. The VCP/VLC systems 22 and 24 are controlled by the control module 5, and provide signal feedback to the control module 5, for example through camshaft rotation position sensors for the intake camshaft and the exhaust camshaft. When the engine 10 is operating in the HCCI combustion mode with an exhaust recompression valve strategy, the VCP/VLC systems 22 and 24 are preferably controlled to the low lift valve openings. When the engine is operating in the homogeneous spark-ignition combustion mode, the VCP/VLC systems 22 and 24 are preferably controlled to the high lift valve openings to minimize pumping losses. When operating in the HCCI combustion mode, low lift valve openings and negative valve overlap can be commanded to generate reformates in the combustion chamber 16. There can be a time lag between a command to change cam phasing and/or valve lift of one of the VCP/VLC systems 22 and 24 and execution of the transition due to physical and mechanical properties of the systems.

The intake and exhaust VCP/VLC systems 22 and 24 have limited ranges of authority over which opening and closing of the intake and exhaust valves 18 and 20 can be controlled. VCP systems can have a range of phasing authority of about 60°-90° of cam shaft rotation, thus permitting the control module 5 to advance or retard valve opening and closing. The range of phasing authority is defined and limited by the hardware of the VCP and the control system which actuates the VCP. The intake and exhaust VCP/VLC systems 22 and 24 may be actuated using one of electro-hydraulic, hydraulic, and electric control force, controlled by the control module 5. Valve overlap of the intake and exhaust valves 20 and 18 refers to a period defining closing of the exhaust valve 18 relative to an opening of the intake valve 20 for a cylinder. The valve overlap can be measured in crank angle degrees, wherein a positive valve overlap (hereafter ‘PVO’) refers to a period wherein both the exhaust valve 18 and the intake valve 20 are open and a negative valve overlap (hereafter ‘NVO’) refers to a period between closing of the exhaust valve 18 and subsequent opening of the intake valve 20 wherein both the intake valve 20 and the exhaust valve 18 are closed. When operating in the HCCI combustion mode, the intake and exhaust valves may have a NVO as part of an exhaust recompression strategy. In an SI-H combustion mode there is a PVO.

The engine 10 includes a fuel injection system, comprising a plurality of high-pressure fuel injectors 28 each adapted to directly inject a mass of fuel into one of the combustion chambers 16, in response to a signal (‘INJ PW’) from the control module 5. The fuel injectors 28 are supplied pressurized fuel from a fuel distribution system.

The engine 10 includes a spark-ignition system by which spark energy is provided to a spark plug 26 for igniting or assisting in igniting cylinder charges in each of the combustion chambers 16 in response to a signal (‘IGN’) from the control module 5. The spark plug 26 enhances the ignition timing control of the engine at certain conditions (e.g., during cold start and near a low load operation limit).

The engine 10 is equipped with various sensing devices for monitoring engine operation, including monitoring crankshaft rotational position, i.e., crank angle and speed. Sensing devices include a crankshaft rotational speed sensor (‘crank sensor’) 42, a combustion sensor 30 adapted to monitor combustion and an exhaust gas sensor 40 adapted to monitor exhaust gases, preferably a wide range air/fuel ratio sensor in this embodiment. The combustion sensor 30 comprises a sensor device operative to monitor a state of a combustion parameter and is depicted as a cylinder pressure sensor operative to monitor in-cylinder combustion pressure. The outputs of the combustion sensor 30, the exhaust gas sensor 40 and the crank sensor 42 are monitored by the control module 5 which determines combustion phasing, i.e., timing of combustion pressure relative to the crank angle of the crankshaft 12 for each cylinder 15 for each combustion cycle. The combustion sensor 30 can also be monitored by the control module 5 to determine a mean-effective-pressure (‘IMEP’) for each cylinder 15 for each combustion cycle. Preferably, the engine 10 and control module 5 are mechanized to monitor and determine states of IMEP for each of the engine cylinders 15 during each cylinder firing event. Alternatively, other sensing systems can be used to monitor states of other combustion parameters within the scope of the disclosure, e.g., ion-sense ignition systems, and non-intrusive cylinder pressure sensors.

The engine 10 is designed to operate un-throttled on gasoline or similar fuel blends in the controlled auto-ignition combustion mode over an extended area of engine speeds and loads. However, spark-ignition and throttle-controlled operation may be utilized under conditions not conducive to the controlled auto-ignition combustion mode and to obtain maximum engine power to meet an operator torque request with engine power defined by the engine speed and load. Widely available grades of gasoline and light ethanol blends thereof are preferred fuels; however, alternative liquid and gaseous fuels such as higher ethanol blends (e.g. E80, E85), neat ethanol (E99), neat methanol (M100), natural gas, hydrogen, biogas, various reformates, syngases, and others may be used.

The control module 5 executes algorithmic code stored therein to control the aforementioned actuators to control engine operation, including throttle position, spark timing, fuel injection mass and timing, intake and/or exhaust valve timing and phasing, and EGR valve position to control flow of recirculated exhaust gases. Valve timing and phasing can include predetermined valve overlap, including NVO and low lift of the intake and exhaust valves 20 and 18 in an exhaust re-breathing strategy. The control module 5 is adapted to receive input signals from an operator, e.g., from a throttle pedal position and a brake pedal position, to determine an operator torque request, and from the sensors indicating the engine speed, intake air temperature, coolant temperature, and other ambient conditions.

The control module 5 is preferably a general-purpose digital computer generally comprising a microprocessor or central processing unit, storage mediums comprising non-volatile memory including read only memory and electrically programmable read only memory, random access memory, a high speed clock, analog to digital and digital to analog circuitry, and input/output circuitry and devices and appropriate signal conditioning and buffer circuitry. The control module has a set of control algorithms, comprising resident program instructions and calibrations stored in the non-volatile memory. The algorithms are preferably executed during preset loop cycles. Algorithms are executed by the central processing unit and are operable to monitor inputs from the aforementioned sensing devices and execute control and diagnostic routines to control operation of the actuators, using preset calibrations. Loop cycles may be executed at regular intervals, for example each 3.125, 6.25, 12.5, 25 and 100 milliseconds during ongoing engine and vehicle operation. Alternatively, algorithms may be executed in response to occurrence of an event.

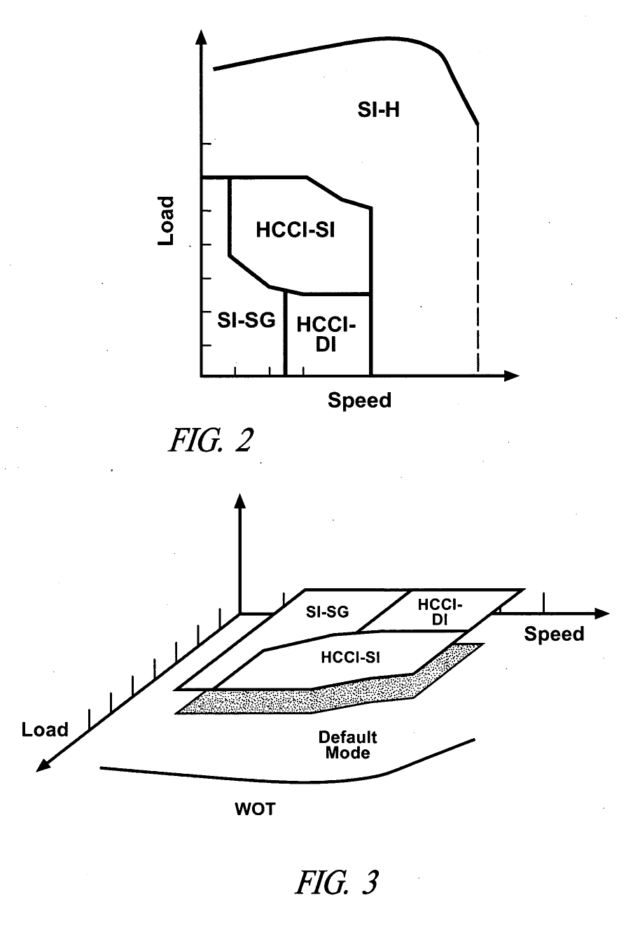

FIG. 2 schematically depicts preferred operating areas for the exemplary engine 10 in spark-ignition and controlled auto-ignition combustion modes, based upon states of engine parameters—in this embodiment comprising speed and load which is derivable from engine parameters including the fuel flow and the intake manifold pressure. The engine combustion modes preferably comprise a spray-guided spark-ignition (‘SI-SG’) combustion mode, a single injection controlled auto-ignition (‘HCCI-SI’) combustion mode, and double injection controlled auto-ignition (‘HCCI-DI’) combustion mode, and a homogeneous spark-ignition (‘SI-H’) combustion mode. A preferred speed and load operating area for each of the combustion modes is based upon engine operating parameters, including combustion stability, fuel consumption, emissions, engine torque output, and others. Boundaries which define the preferred speed and load operating areas to delineate operation in the aforementioned combustion modes are preferably precalibrated and stored in the control module 5.

The engine 10 is controlled to operate at a preferred air-fuel ratio and the intake air flow is controlled to achieve the preferred air-fuel ratio. This includes estimating a cylinder air charge based upon engine operation in the selected combustion mode. The throttle valve 34 and VCP/VLC devices 22 and 24 are controlled to achieve an intake air flowrate based upon the estimated cylinder air charge, including during a transition between the spark-ignition and controlled auto-ignition combustion modes. Air flow is controlled by adjusting the throttle valve 34 and the VCP/VLC devices 22 and 24 to control the opening timing and profiles of the intake and exhaust valve(s) 20 and 18. Operation in the two combustion modes requires different settings for the VCP/VLC devices 22 and 24 in terms of valve timing and profiles of the intake and exhaust valve(s) 20 and 18 and the throttle valve 34 for throttle position. By way of example, the throttle valve 34 is preferably wide-open in the auto-ignition combustion mode with the engine 10 controlled at a lean air-fuel ratio, whereas the throttle valve 34 is controlled to regulate the air flow and the engine 10 is controlled to a stoichiometric air-fuel ratio in the spark-ignition combustion mode.

FIG. 3 depicts a control strategy for controlling and operating the engine 10 described with reference to FIGS. 1 and 2 in one of the combustion modes. One of the combustion modes is selected and designated as a default combustion mode. In this embodiment, the SI-H combustion mode is designated the default combustion mode. The other combustion modes are designated elective combustion modes. The speed and load operating limit of the default combustion mode is defined in FIG. 3 by the wide-open-throttle line labeled ‘WOT’ which indicates it is operative within the entire speed/load operating area of the engine. The elective combustion modes are superimposed on the default combustion mode to depict the relative speed/load parameters as shown in FIG. 3. The engine 10 can operate in the default combustion mode over the entire speed/load operating area in this embodiment.

Preferably, the default combustion mode comprises the combustion mode whereat the engine 10 is operative over a broad area of engine speeds and loads. It is preferable for the engine 10 to operate in the default combustion mode with minimum control of some of the actuators, e.g., VCP/VLC systems 22 and 24, and with minimum feedback from sensors and sensing systems, and with minimum algorithmic executions. Thus the engine 10 can operate over a wide area of speed/load combinations with limited capability in sensing and actuation. For the exemplary engine 10, the SI-H mode is the preferred default combustion mode. The other combustion modes, e.g., the SI-SG mode, the HCCI-SI mode, and HCCI-DI mode, are the elective combustion modes that are graphically superimposed on the default combustion mode as shown in FIG. 3.

The control module 5 executes algorithmic code stored therein to generate control settings for the aforementioned actuators based upon monitored outputs from the sensors. The control settings include throttle position, spark timing, fuel injection mass and timing, intake and/or exhaust valve lift, timing and phasing, and EGR valve position to control flow of recirculated exhaust gases. The control module 5 monitors input signals from an operator including an accelerator pedal position and a brake pedal position to determine an operator torque request and monitors the sensors indicating the engine speed, load, intake air mass temperature, coolant temperature, and other ambient conditions. The control module 5 operates to determine, preferably from lookup tables in memory, control settings for the actuators, including spark timing (as needed), EGR valve position, intake and exhaust valve timing and two-step lift transition set points, and fuel injection mass and timing. The control module 5 executes algorithmic code for operating the engine 10 in the default combustion mode at all times during engine operation regardless of which of the selected combustion modes the engine 10 is operating in at the time. The executed algorithmic code is used to control the engine 10 in the default combustion mode when the control module 5 selects the default combustion mode.

When the engine 10 is operating within an engine operating area encompassed by one of the elective combustion modes, the control module 5 preferentially operates the engine 10 in the elective combustion mode by executing control algorithms to control engine operation in the elective combustion mode. The control module 5 concurrently executes control algorithms operable to control the engine 10 using the default combustion mode. This includes monitoring inputs from sensors and determining actuator settings to operate the engine 10 in the default mode, including control settings for fuel injector pulse width (INJ PW), exhaust gas recirculation (EGR), intake air (ETC), and spark-ignition timing and dwell (IGN). The actuator control settings are determined based upon monitored engine operating conditions to meet the operator torque request when operating the engine in the default mode. In so doing, upon occurrence of an event, e.g., a fault which necessitates or causes the engine to exit the presently elected combustion operating mode, the control module 5 is able to switch operation of the engine 10 from the elective combustion mode to the default combustion mode with minimal delay and with minimal disruption of engine operation. Events which may necessitate switching engine control out of the elective combustion mode can include detection of component or system faults using, e.g., on-board sensing systems and diagnostic algorithm. Faults can include component faults on the combustion sensor 30, the intake VCP/VLC system 22, and the exhaust VCP/VLC system 24.

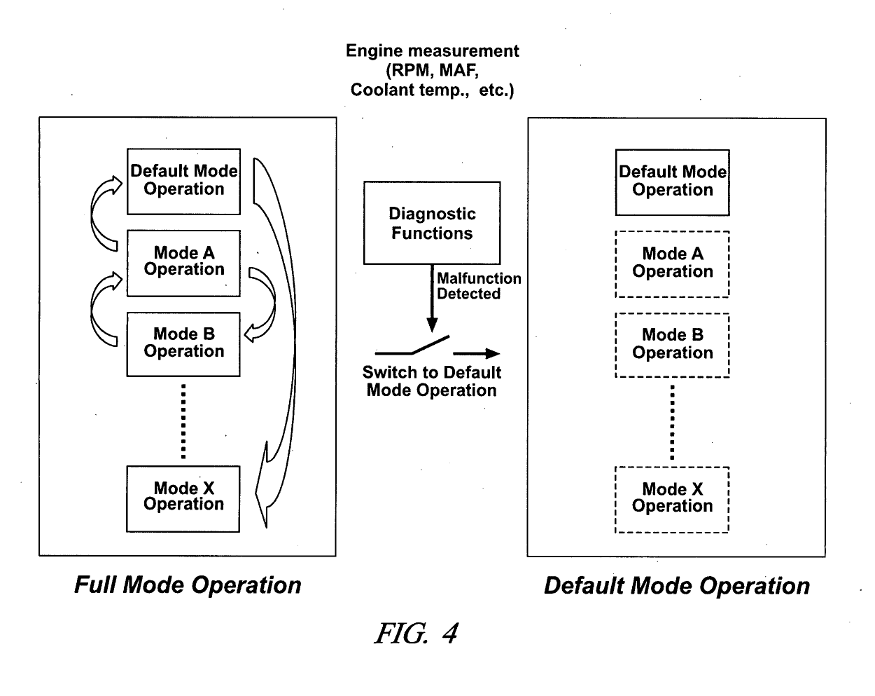

FIG. 4 depicts exemplary operation of the system. During full mode operation, the control module 5 selects and controls engine operation, including transitioning between the default combustion mode operation and one or more of the elective combustion mode operations, depicted as combustion Mode A, combustion Mode B and on through combustion Mode X including any number of alternative operating combustion modes. With reference to the engine described hereinabove, the default mode comprises the SI-H combustion mode and the elective combustion modes comprise the SI-SG combustion mode, the HCCI-SI combustion mode, and the HCCI-DI combustion mode. Engine operation is monitored, and diagnostic algorithms are executed. When a fault is detected by one of the diagnostic algorithms, the control module immediately commands engine operation in the default combustion mode, regardless of the operating conditions.

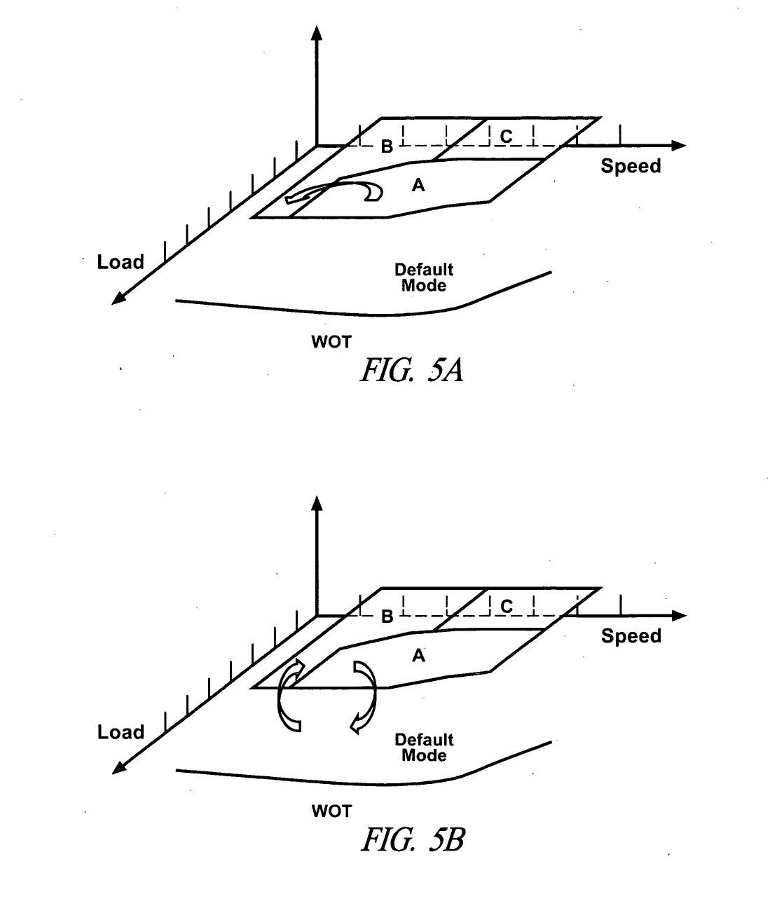

The abovementioned method increases transitioning flexibility among the combustion modes. As depicted in FIGS. 5A and 5B, there are two possible routes to transition from combustion Mode A to combustion Mode B. FIG. 5A depicts a direct transition from combustion Mode A to combustion Mode B. FIG. 5B depicts a transition from combustion Mode A to combustion Mode B using the default combustion mode as an intermediary combustion mode. In some cases, the transition depicted in FIG. 5B may be preferred because transitions between each of the elective combustion modes and the default mode may be more robust and easier to implement than direct transitions, depending upon characteristics of the engine 10.

The same method as described hereinabove is applicable to engines selectively operative in multiple combustion modes, described with reference to an embodiment comprising a spark-ignition engine. An alternative application of the method can utilize an embodiment of a compression-ignition engine that is selectively operative in a compression-ignition (hereafter ‘CI’) combustion mode and a premixed-charge compression ignition (hereafter ‘PCCI’) combustion mode. In one embodiment, the CI combustion mode is preferably the default combustion mode, and the PCCI combustion mode is the elective combustion mode. The PCCI combustion mode comprises partial injection of fuel early in the compression stroke of the combustion cycle leading to premixed fuel and intake air in the combustion chamber to effect low temperature combustion.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. Method for operating an internal combustion engine selectively operative in first and second combustion modes and operatively connected to a control module including a plurality of executable algorithms, comprising:
monitoring an engine operating point;
concurrently executing a first algorithm operable to control the engine in the first combustion mode and executing a second algorithm operable to control the engine in the second combustion mode;
preferentially operating the engine in the second combustion mode when the engine operating point is within a predetermined operating area for the second combustion mode; and
selectively operating the engine in the first combustion mode.

2. The method of claim 1, wherein the predetermined operating area for the second combustion mode encompasses less than an entire operating area for the first combustion mode.

3. The method of claim 2, further comprising:
monitoring engine operation; and
selectively operating the engine in the first combustion mode when a fault is detected in the engine operation.

4. The method of claim 3, further comprising:
transitioning engine operation from the second combustion mode to the first combustion mode when the engine fault is detected.

5. The method of claim 4, further comprising:
transitioning engine operation from the second combustion mode to the first combustion mode when the engine fault is identified in engine components comprising one of a combustion sensor, a variable cam phaser system and a variable lift control device.

6. The method of claim 1, further comprising:
transitioning engine operation from the second combustion mode to a third combustion mode through an intermediate engine operation in the first combustion mode.

7. The method of claim 6, further comprising:
discontinuing executing the second algorithm operable to control the engine in the second combustion mode; and
executing a third algorithm operable to control the engine in the third combustion mode.

8. The method of claim 7, further comprising continuously executing the first algorithm operable to control the engine in the first combustion mode during engine operation.

9. The method of claim 1, wherein the first combustion mode comprises a spark-ignition combustion mode and the second combustion mode comprises one of a spray-guided spark-ignition combustion mode, a single injection auto-ignition combustion mode, and a double injection auto-ignition combustion mode.

10. The method of claim 1, wherein the first combustion mode comprises a compression-ignition combustion mode and the second combustion mode comprises a premixed-charge compression ignition combustion mode.

11. The method of claim 1, wherein the first combustion mode comprises a default combustion mode and the second combustion mode comprises an elective combustion mode.

12. Method for operating an internal combustion engine selectively operative in one of a default combustion mode and one of a plurality of elective combustion modes, said engine operatively connected to a control module including a plurality of executable algorithms, comprising:
monitoring an engine operating point;
monitoring engine operation;
concurrently executing a first algorithm operable to control the engine in the default combustion mode and executing a second algorithm operable to control the engine in a first one of the plurality of elective combustion modes;
preferentially operating the engine in the first one of the plurality of elective combustion mode when the engine operating point is within a predetermined operating area for the first one of the plurality of elective combustion modes; and
selectively operating the engine in the default combustion mode when the engine operating point is within the predetermined operating area for the first one of the plurality of elective combustion modes.

13. The method of claim 12, wherein respective predetermined operating areas for each of the plurality of elective combustion modes encompasses less than an entire operating area for the default combustion mode.

14. The method of claim 12, further comprising transitioning engine operation from the first one of the plurality of elective combustion modes to the default combustion mode when an engine fault is identified in engine components comprising one of a combustion sensor, a variable cam phaser system and a variable lift control device.

15. The method of claim 12, further comprising transitioning among the plurality of elective combustion modes based upon the engine operating point and respective predetermined operating areas for each of the plurality of elective combustion modes.

16. The method of claim 12, further comprising:
transitioning engine operation from the first one of the plurality of elective combustion modes to a second one of the plurality of elective combustion modes through an intermediate engine operation in the default combustion mode.

17. The method of claim 16, further comprising:
discontinuing executing the second algorithm operable to control the engine in the first of one of the plurality of elective combustion modes; and
executing a third algorithm operable to control the engine in the second one of the plurality of elective combustion modes.

18. The method of claim 12, wherein the default combustion mode comprises a spark-ignition combustion mode, and wherein the plurality of elective combustion modes comprises a spray-guided spark-ignition combustion mode, a single injection auto-ignition combustion mode, and a double injection auto-ignition combustion mode.

19. Method for operating an internal combustion engine selectively operative in a plurality of combustion modes and operatively connected to a control module including a plurality of executable algorithms, comprising:
monitoring an engine operating point;
concurrently executing a first algorithm operable to control the engine in a first combustion mode and executing a second algorithm operable to control the engine in a second combustion mode;
preferentially operating the engine in the second combustion mode when the engine operating point is within a predetermined operating area for the second combustion mode and the predetermined operating area for the second combustion mode is less than an operating area for the first combustion mode; and
selectively operating the engine in the first combustion mode.
